(19) United States
(12) Patent Application Publication
(10) Pub. No.: US 2021/0362170 A1
(43) Pub. Date: Nov. 25, 2021

(54) MIST GENERATING DEVICE

(71) Applicant: CBC Co.,Ltd., Tokyo (JP)

(72) Inventor: Yoshihisa HAYASHI, Osaka (JP)

(21) Appl. No.: 17/033,145

(22) PCT Filed: Feb. 18, 2020
(86) PCT No.: PCT/JP2020/006172

§ 371 Date: Sep. 25, 2020

(30) Foreign Application Priority Data
Jun. 10, 2019 (JP) 2019-108247

(51) Int. Cl. B05B 3/02; B05B 3/00; A61H 33/00; A61H 33/06

(52) U.S. Cl. CPC B05B 3/022; B05B 3/001; A61H 33/6052; A61H 33/063; A61H 33/0087

(57) ABSTRACT

The mist generating device includes a housing 11 having a water tank 12; a shaft portion 13 provided in the housing and extending in a vertical direction; an impeller 14 disposed on the shaft portion to be rotatable by means of the motor in a horizontal direction about a rotation axis that is the shaft portion; a nozzle 15 for jetting the water in the water tank toward the impeller; and a pump 21 for delivering the water in the water tank to the nozzle. The impeller includes a plurality of blades 14a arranged along a rotation direction of the impeller and configured to collide with the water jetted from the nozzle. The water jetted from the nozzle collides with the blades to thereby smash the water and generate mist. The housing includes a mist releasing port 18 for releasing the mist generated in the housing outwardly of the housing.

### TECHNICAL FIELD

The present disclosure relates to a mist generating device, and more particularly, to a mist generating device used for mist saunas, and mist baths for elderly person's or patient's arms and legs.

### BACKGROUND ART

It is well known that exposure to mist which is atomized hot water or water promotes perspiration and improves blood circulation even when the mist is at lower temperatures. It is also well known that exposure to such mist increases metabolism and improves effects of holding water in the skin. In particular, exposing to the mist the whole body or body parts, such as arms and legs, of an elderly person and a patient who are bedridden and cannot take a bath, may lead to the occurrence of relaxation of mind and body, and is particularly beneficial. In this respect, when a particle diameter of the mist is larger in a mist bath, mist particles in contact with the human body unite with each other to make larger-diameter water droplets, which causes wetness and thus give unpleasantness and then reduces the effects of the mist bath. For this reason, it has come to attention that the particle diameter of the mist is desirably made as small as possible.

Previously, various devices for realizing a mist bath have been proposed. For example, Patent literatures 1 and 2 each disclose a mist generating device that is provided with an impeller having a plurality of blades extending across a rotation direction and arranged in a circle and that causes a jet flow jetted from a plurality of nozzles to collide with the blades to generate mist with a smaller particle diameter. In those mist generating devices, water in a water tank provided inside the devices is heated by a heater and the heated water in the water tank is jetted from the nozzles. This enables generation of the mist with a smaller diameter and at higher temperature, which is suitable for a mist bath.

### CITATION LIST

### PATENT LITERATURE

[Patent Literature 1] Japanese Patent No. 6345065

[Patent Literature 2] Japanese Patent No. 6118563

### SUMMARY OF INVENTION

### Technical Problem

In this respect, the mist generating devices disclosed in Patent literatures 1 and 2 cause the water jetted from the nozzles to collide with the blades of the impeller to thereby drive the impeller in rotation, and thus, the water needs to be jetted from the nozzles at relatively high velocity. For that reason, the mist generating devices disclosed in Patent literatures 1 and 2 require a pump capable of generating relatively high pressure and also need smaller diameter nozzles. Then, the need of a pump having relatively high performance may result in higher cost. The smaller diameter nozzles also may lead to a breakdown due to clogs with dust, etc., and may cause a user to perform frequent maintenance.

The impeller is then driven in rotation by colliding with the water jetted from the nozzles, and thus, a rotational speed of the impeller may not be constant due to pressure of a pump applied for jetting the water and a load applied to a rotation axis of the impeller, for example. A diameter of the mist obtained then varies in accordance with the rotational speed of the impeller. Thus, the mist generating devices of Patent literatures 1 and 2 may not stably produce mist having a desirable particle diameter.

The present disclosure is made in view of the above-mentioned problem, and an object of the present disclosure is to enable prevention of a breakdown of the device, and constant rotation of the impeller at a desirable speed, and production of the mist having a desirable diameter.

### SOLUTION TO PROBLEM

To attain the above-mentioned object, the present disclosure is enabled by a mist generating device including a motor for turning an impeller.

Specifically, a mist generating device according to the present disclosure includes: a housing having a water tank for storing water; a heater provided in the water tank for heating the water in the water tank; a shaft portion provided in the housing and extending in a vertical direction; a motor connected to the shaft portion; an impeller disposed on the shaft portion to be rotatable by means of the motor in a horizontal direction about a rotation axis that is the shaft portion; and a nozzle for jetting the water in the water tank toward the impeller; and a pump for delivering the water in the water tank to the nozzle. The impeller includes: a plurality of blades arranged along a rotation direction of the impeller and configured to collide with the water jetted from the nozzle; and an upper plate and a lower plate situated on upper ends and lower ends of the plurality of blades, respectively, and arranged to sandwich the plurality of blades. The water jetted from the nozzle collides with the blades to thereby smash the water and generate mist. The housing is provided with a mist releasing port for releasing the mist generated in the housing outwardly of the housing.

According to the mist generating device of the present disclosure, the motor is connected to the shaft portion and the impeller is arranged to be rotatable by means of the motor in the horizontal direction about the rotation axis that is the shaft portion, so that the impeller can be rotated without the water jetted from the nozzle. The impeller thus can be rotated at a desirable rotational speed by the motor. This eliminates the need of having a smaller diameter of an opening of the nozzle and of generating relatively high pressure of the pump delivering water to the nozzle, and enables stable production of the mist having a desirable diameter. Moreover, the nozzle does not need to have a smaller diameter of the opening as described above, thus preventing the nozzles from being clogged with dust, etc., and causing a breakdown, and the maintenance frequency from increasing.

In the mist generating device according to present disclosure, a diameter of the opening of the nozzle is preferably more than or equal to 5 mm

This permits effective prevention of the nozzles from being clogged with dust, etc., avoidance of a breakdown of the device, and easier maintenance, as described above.

In the mist generating device according to present disclosure, it is preferable that the housing is provided with an outside air introducing port for introducing outside air into the housing, that the outside air introducing port is provided with an outside air introducing means for actively introducing outside air into the housing, that a diameter of an opening of the mist releasing port is smaller than that of the outside air introducing port, and that an interior of the housing is configured to be pressurizable by the active introduction of outside air into the housing by the outside air introducing means.

This enables increased pressure in the housing of the device since the outside air introducing means actively introduces outside air into the device and the diameter of the opening of the mist releasing port is smaller than that of the outside air introducing port. For this reason, vaporization of the mist can be prevented and a retained heat amount of the mist can be increased, so that a decrease in temperature of a mist flow released from the device can be prevented. As a result, mist suitable for mist baths, higher in temperature, and smaller in particle diameter can be obtained without a complex structure and higher cost.

In the mist generating device according to the present disclosure, it is preferable that the upper plate or the lower plate includes an opening at a center thereof.

In that way, the rotation of the impeller generates an air flow from upper or lower side of the impeller through an interior of the impeller toward an exterior of the impeller, to enable excellent dispersion of the generated mist from the impeller.

### ADVANTAGEOUS EFFECTS OF INVENTION

Accordingly, the mist generating device according to the present disclosure enables prevention of a breakdown of device parts, and constant rotation of the impeller at a desirable speed, and production of the mist having a desirable diameter.

### BRIEF DESCRIPTION OF DRAWINGS

FIG. 1 is an exploded perspective view showing a mist generating device according to an embodiment of the present disclosure.

FIG. 2 is a longitudinal cross-sectional view showing a mist generating device according to an embodiment of the present disclosure.

FIG. 3 is a schematic view for explaining a mist generating mechanism in a mist generating device according to an embodiment of the present disclosure.

FIG. 4 is a schematic view showing a mist generating device in use, according to an embodiment of the present disclosure.

FIG. 5 is a longitudinal cross-sectional view showing a mist generating device according to a variant of the embodiment of the present disclosure.

### DESCRIPTION OF EMBODIMENTS

Embodiments of the present disclosure are described below with reference to the drawings. The following description of preferred embodiments is merely an example in nature, and is not intended to limit the present disclosure, application method thereof, or use thereof

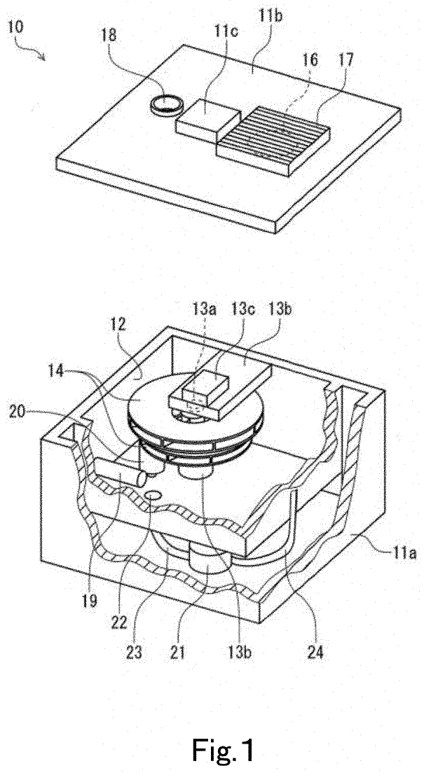

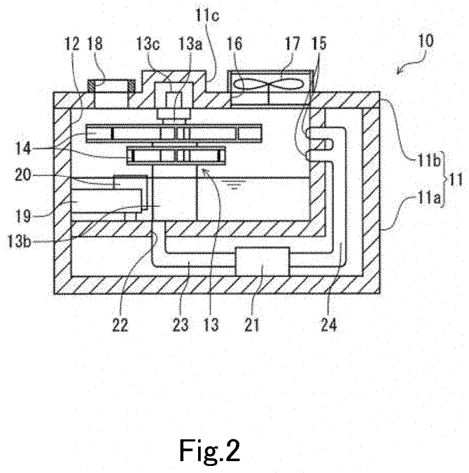

A mist generating device according to an embodiment of the present disclosure is described with reference to FIGS. 1 to 3.

As shown in FIGS. 1 to 3, a mist generating device 10 according to the embodiment includes a housing 11 formed of a body portion 11a and a lid portion 11b. The lid portion 11b is removably attached to the body portion 11a with a screw or the like. A water tank 12 for storing water is provided inside the housing 11. A shaft portion 13, an impeller 14, and a nozzle 15 are provided inside the water tank 12. The shaft portion 13 extends in the vertical direction. The impeller 14 is disposed to be rotatable in the horizontal direction about a rotation axis that is the shaft portion 13. The nozzle 15 is configured to jet the water of the water tank 12 toward the impeller 14. An outside air introducing port 16 for introducing outside air into the housing 11 is then provided in the lid portion 11b of the housing 11. The outside air introducing port 16 is provided with a fan 17 as an outside air introducing means for actively introducing outside air into the housing 11. Further, a mist releasing port 18 for releasing mist generated in the housing 11 into the outside of the housing 11 is provided in the lid portion 11b.

The water tank 12 is provided with a heater 19 for heating the stored water and a float switch 20 for detecting that a predetermined amount of water is stored in the water tank 12. The water in the water tank 12 is heated by the heater 19 and the heated water is jetted from the nozzle 15 by means of a pump 21 provided inside the housing 11. Specifically, the pump 21 is connected to a suction hose 23 and a sending-out hose 24. The suction hose 23 is connected to the water tank 12 through a suction hole 22 provided at the bottom of the water tank 12 and the sending-out hose 24 is connected to the nozzle 15. Thus, the water in the water tank 12 is sucked in the suction hose 23 through the suction hole 22 by operation of the pump 21 and passes through the sending-out hose 24 to be jetted from the nozzle 15. In the embodiment, while not being shown, a pump for delivering water from a certain source of water to the water tank 12 may be provided aside from the pump 21 for delivering the water to the nozzle 15. Then, operation of the pump for delivering water to the water tank 12 may be controlled on the basis of detection by the float switch 20.

The shaft portion 13 is formed of, specifically, a rotation shaft 13a extending in the vertical direction in the water tank 12, and bearing portions 13b provided at bottom and upper parts of the water tank 12 and supporting the lower and upper ends of the rotation shaft 13a. The shaft portion 13 also includes a motor 13c connected to the rotation shaft 13a to turn the rotation shaft 13a. In the embodiment, the motor 13c is mounted on the bearing portion 13b of the shaft portion 13, but not limited to this configuration. In the embodiment, the lid portion 11b then includes a protruding portion 11c protruding upward at a position corresponding to the motor 13c to mount the motor 13c on the bearing portion 13b. In this respect, when the motor 13c is disposed at another position which renders the need of the protruding portion 11c unnecessary, the protruding portion 11c is naturally eliminated. While not being shown, the motor 13c also includes a power source for driving the motor 13c and a controller for controlling rotational speed of the motor 13c. Rotation of the motor 13c can also be controlled either in forward or reverse direction.

The impeller 14 attached to be rotated in the horizontal direction as the rotation shaft 13a is turned by the motor 13c is provided on the rotation shaft 13a of the shaft portion 13. In the embodiment, the impeller 14 includes two impellers 14 that are arranged one above another. A lower impeller 14 then has a smaller diameter than an upper impeller 14. The lower impeller 14 with a smaller diameter can suppress creation of waves on the surface of the water in the water tank 12 which is caused by the rotation of the impellers 14, and thus can prevent occurrence of an abnormal detection by the float switch 20. However, the embodiment is not limited to this configuration. The upper impeller 14 may have a smaller diameter than the lower impeller 14, or the upper and lower impellers 14 may have a same diameter. Moreover, the embodiment is not limited to the two impellers 14. One, or three or more of the impellers 14 may be provided.

In the embodiment, the nozzle 15 includes two nozzles 15 that are provided at positions corresponding to vertical positions of the two impellers 14, respectively. The impellers 14 are each formed of a plurality of blades 14a arranged along a rotation direction of the impellers 14, and an upper plate 14b and a lower plate 14c situated on the upper and lower ends of the plurality of blades 14a, respectively, and arranged to sandwich the plurality of blades. It is preferable that the blades 14a are particularly configured and arranged to have a shape facilitating creation of an air flow in the impellers 14 by the rotation of the impellers 14. This enables active introduction of outside air into the housing 11 through the outside air introducing port 16 and thus pressurization in the housing 11. An effect produced by pressurizing in the housing 11 will be described below.

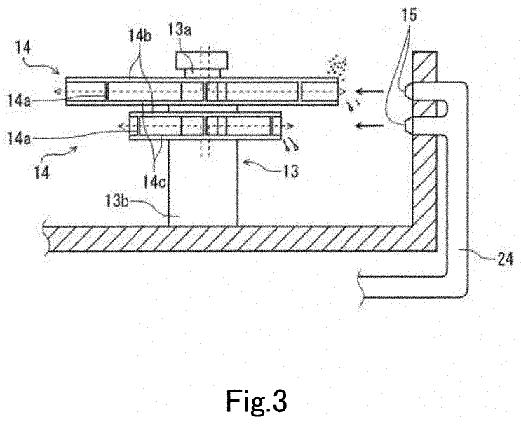

With the above-described structure of the mist generating device 10 and as shown in FIG. 3, when water is jetted from the nozzles 15 toward the impellers 14 that rotate in the horizontal direction on the rotation shaft 13a that is an axial center with the rotation shaft 13a being turned by the motor 13c, the water collides with the blades 14a of the impellers 14. The water having collided with the blades 14a turns into mist and spray including water droplets to scatter in different directions. Thereby, mist is generated. In the operation, since the rotation shaft 13a for the impellers 14 is fixed in the vertical direction as described above and a centrifugal force therefore acts in the horizontal direction, the mist with a comparatively smaller diameter scatters and floats inside the water tank 12. On the other hand, the spray with a larger diameter does not scatter upward and falls to a lower part of the water tank 12 where the water is stored. As a result, only the mist with a smaller diameter can be selectively taken out.

In the embodiment, it is also preferable that the upper plate 14b of the upper impeller 14 includes an opening at the center thereof and the lower plate 14c of the lower impeller 14 includes an opening at the center thereof. In this way, the rotation of the impellers 14 generates an air flow towards the impellers 14 as described above, and specifically, generates an air flow from the upper and lower openings of the respective upper and lower impellers 14 through an interior of the impellers 14 toward an exterior of the impellers 14, to enable excellent dispersion of the generated mist from the impellers 14 (see dashed arrows in FIG. 3).

In the embodiment, the impellers 14 is turned by the motor 13 and thus, there is no need of a smaller diameter of openings of the nozzles. The diameter of openings of the nozzles is preferably more than or equal to 5 mm, for example. This permits prevention of the nozzles from being clogged with dust, avoidance of a breakdown of the device, and easier maintenance.

In the mist generating device 10 according to the embodiment, the outside air introducing port 16 is provided with the fan 17 as an outside air introducing means as described above, and outside air is then introduced into the housing 11 by operation of the fan 17. As a result, the mist generated and floating inside the housing 11 is moved by air flow introduced from the outside air introducing port 16 and is released from the mist releasing port 18. Moreover, in the mist generating device 10 according to the embodiment, an interior of the housing 11 is pressurized by the operation of the fan 17, and a diameter of an opening of the mist releasing port 18 is particularly smaller than a diameter of an opening of the outside air introducing port 16.

The mist generating device 10 according to the embodiment includes the heater 19 in the water tank 12 and water is then heated by the heater 19 as described above, and steam thus exists inside the water tank 12. In the conventional mist generating devices, mist is vaporized as described above, resulting in decreased temperature of released mist flow. In contrast, the mist generating device according to the embodiment is configured to pressurize the interior of the housing 11 as described above, so that vaporization of the mist is prevented and a retained heat amount of the mist can be increased. As a result, a decrease in temperature of a mist flow released from the device can be prevented.

In the embodiment, while not being shown, a known power source, wiring, temperature setting device, and temperature sensor formed of a thermocouple, and the like, for operating the fan 17, heater 19, and pump 21, can be suitably adopted.

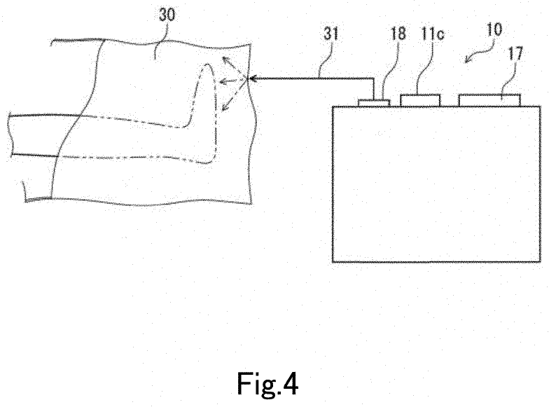

Next, an example of a use configuration of the mist generating device 10 according to the embodiment will be described with reference to FIG. 4. A use configuration where the mist generating device 10 is used for a mist bath for a leg will be described. As shown in FIG. 4, the mist generating device 10 can be used in such a manner that the mist releasing port 18 of the mist generating device 10 and a bag member 30 for a user to put his/her leg in are connected by a hose 31, so that the mist released from the mist releasing port 18 is introduced into the bag member 30. This enables the user's leg to have a mist bath with the mist having a smaller particle diameter. While the use configuration of a mist bath for a leg is shown in this example, a use in a mist bath for the whole body is enabled by changing the size of the bag member 30.

The outside air introducing port 16 and the mist releasing port 18 are provided in the lid portion 11b of the housing 11 in the mist generating device 10 according to the embodiment; however, they may be provided in the body portion 11a. In this respect, the mist releasing port 18 is preferably provided in a part as upper as possible from the viewpoint of preventing spray with a larger diameter from reaching the mist releasing port 18. The two impellers 14 are then provided on the shaft portion 13; however, the embodiments are not limited to this configuration. One, or three or more of the impellers 14 may be arranged. In this respect, a number of the nozzles 15 corresponding to the number of impellers 14 are provided.

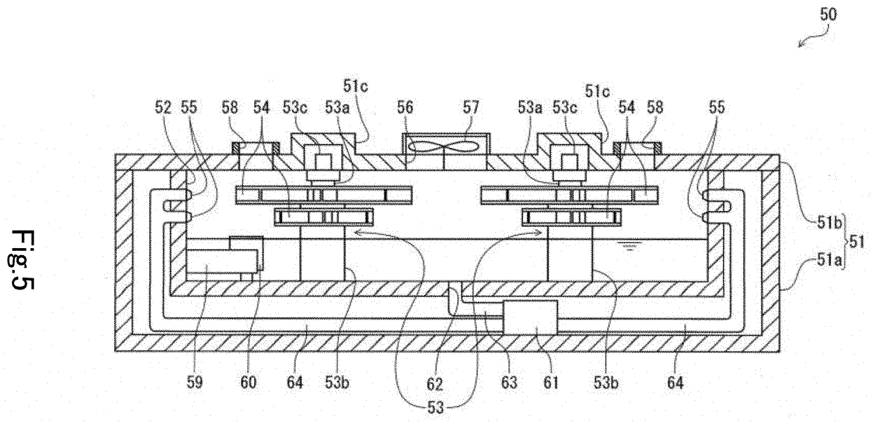

Next, a mist generating device 50 according to a variant of the embodiment will be described. As compared with the mist generating device 10 according to the above-described embodiment, the mist generating device 50 according to the variant embodiment is different in that two shaft portions are provided, two impellers are provided on the respective shaft portions, and two mist releasing ports are provided. The mist generating device 50 according the variant embodiment will be described below with reference to FIG. 5. Configurations of the mist generating device 50 same as those of the mist generating device 10 according to the embodiment will not be described.

As shown in FIG. 5, two shaft portions 53 are arranged along the horizontal direction inside a water tank 52 provided in a housing 51 of the mist generating device 50 according to the variant embodiment. A motor 53c for turning a rotation shaft 53b of the shaft portion 53 is then connected to the shaft portion 53. On each of the two shaft portions 53, two impellers 54 arranged one above another are disposed to be rotatable in the horizontal direction. A total of four nozzles 55 for jetting water to the impellers 54 are thus provided such that each of the nozzles 55 is placed at a position corresponding to respective one of the impellers 54. The four nozzles 55 are connected through a sending-out hose 64 to a pump 61 provided inside the housing 51. Water is jetted from the four nozzles 55 by operation of the pump 61. In the variant embodiment, the multiple impellers 54 are thus arranged, enabling an increased amount of generated mist.

In the variant embodiment, two mist releasing ports 58 are then arranged in a lid portion 51b of the housing 51. Two people thus can utilize one mist generating device 50 at the same time. Even in that case, the variant embodiment includes the multiple impellers 54 for generating mist as described above and causes a larger amount of the generated mist. Even when the mist is released from the two mist releasing ports 58, a decrease in an amount of the released mist from each of the mist releasing ports 58 can be thus prevented.

Moreover, in the variant embodiment, the mist generating device 50 according to the variant embodiment is, similarly to the mist generating device 10 according to the embodiment, configured to pressurize an interior of the housing 51 by means of operation of a fan 57 and a diameter of an opening of the mist releasing port 58 is smaller than a diameter of an opening of an outside air introducing port 56. In particular, the variant embodiment includes the outside air introducing port 56 having the opening of a larger diameter to thereby increase in an amount of introduced outside air, enables the pressurization of the interior of the housing 51 even when there are the two mist releasing ports 58, and then provides the mist sufficiently released from the two mist releasing ports 58.

Accordingly, a mist generating device according to the present disclosure enables prevention of a breakdown of device parts, and constant rotation of an impeller, and production of desirable mist, and is thus particularly useful.

### DESCRIPTION OF REFERENCE CHARACTERS

10, 50 Mist generating device

11, 51 Housing

12, 52 Water tank

13, 53 Shaft portion

13c, 53c Motor

14, 54 Impeller

15, 55 Nozzle

16, 56 Outside air introducing port

17, 57 Fan

18, 58 Mist releasing port

19, 59 Heater

20, 60 Float switch

21, 61 Pump

22, 62 Suction hole

23, 63 Suction hose

24, 64 Sending-out hose

1. A mist generating device comprising:
a housing having a water tank for storing water;
a heater provided in the water tank for heating the water in the water tank;
a shaft portion provided in the housing and extending in a vertical direction;
a motor connected to the shaft portion;
an impeller disposed on the shaft portion to be rotatable by means of the motor in a horizontal direction about a rotation axis that is the shaft portion;
a nozzle for jetting the water in the water tank toward the impeller; and
a pump for delivering the water in the water tank to the nozzle;
wherein the impeller includes a plurality of blades arranged along a rotation direction of the impeller and configured to collide with the water jetted from the nozzle; and an upper plate and a lower plate situated on upper ends and lower ends of the plurality of blades, respectively, and arranged to sandwich the plurality of blades,
wherein the water jetted from the nozzle collides with the blades to thereby smash the water and generate mist,
wherein the housing is provided with a mist releasing port for releasing the mist generated in the housing outwardly of the housing.

2. The mist generating device according to claim 1, wherein a diameter of an opening of the nozzle is more than or equal to 5 mm.

3. The mist generating device according to claim 1, wherein the housing is provided with an outside air introducing port for introducing outside air into the housing and the outside air introducing port is provided with an outside air introducing means for actively introducing outside air into the housing,
wherein a diameter of an opening of the mist releasing port is smaller than that of the outside air introducing port and an interior of the housing is configured to be pressurizable by the active introduction of outside air into the housing by the outside air introducing means.

4. The mist generating device according to claim 1, wherein the upper plate or the lower plate includes an opening at a center thereof.
